(19) United States
(12) Patent Application Publication
(10) Pub. No.: US 2009/0071443 A1
(43) Pub. Date: Mar. 19, 2009

(54) Fuel Injection Control Apparatus for Internal Combustion Engine

(75) Inventors: Takao Miyake, Hitachinaka (JP); Shogo Ide, Hitachiota (JP)

Correspondence Address: CROWELL & MORING LLP;INTELLECTUAL PROPERTY GROUP, P.O. BOX 14300, WASHINGTON, DC, 20044-4300, US

(73) Assignee: Hitachi, Ltd., Tokyo (JP)

(21) Appl. No.: 12/194,206

(22) Filed: Aug. 19, 2008

(30) Foreign Application Priority Data
Sep. 19, 2007 (JP) 2007-241721

(51) Int. Cl. F02M 61/16

(52) U.S. Cl. 123/446

(57) ABSTRACT

A fuel injection control apparatus for an engine including one or more sensors to detect one or more operational states of engine and a fuel state, a fuel injector to activate a plunger rod thereof to inject fuel when an excitation current is supplied to a coil of the fuel injector, and a unit for precharging the coil of the fuel injector with an excitation current smaller than that required to activate the plunger rod of the fuel injector, wherein the current to be precharged to the fuel injector is adjusted according to the one ore more operational states of the engine detected by the one or more sensors.

### BACKGROUND OF THE INVENTION

The present invention relates to a fuel injection control apparatus for an internal combustion engine.

The internal combustion engine have a fuel injection control apparatus that calculates an appropriate volume of fuel to be injected according to an operational state of the engine and drives a fuel injector for injecting fuel. The fuel injector opens and closes a plunger rod of the fuel injector to inject fuel by a magnetic force that is generated by an electric current passing through a coil. An amount of fuel to be injected is determined mainly by a difference between a fuel pressure and a peripheral pressure at a nozzle hole of the fuel injector and a time that the plunger rod is kept open to allow the fuel to be injected. Therefore, to inject an appropriate amount of fuel, it is necessary to set the time during which to keep the fuel injector open according to the fuel pressure and at the same time execute the opening and closing operation of the plunger rod swiftly and accurately.

However, there is a time delay from the start of energizing the fuel injector until the plunger rod is actually operated. This delay in the plunger rod open-close operation is caused by, for example, moving parts in the injector, a fluid force caused by the pressure and viscosity of fuel present around the plunger rod, and a response delay of electric circuits. It has therefore been a common practice to consider these response delays in setting an energization time of the fuel injector.

There is another method available (JP-A-55-40391) that involves applying to an electromagnetic control unit in advance an electric current of a magnitude that does not result in a full response of the electromagnetic control unit (hereinafter called a precharge) and then later, at a desired timing, applying an additional signal to an excitation winding of the electromagnetic control unit to fully operate it, thereby minimizing the response delay.

Since the magnetic force generated by the coil of the fuel injector depends on a magnitude of an applied current, it is influenced by coil inductance and resistance variations in the drive circuit and wires, degrading an accuracy of the open-close speed of the plunger rod. To deal with this problem, a method has been proposed that stabilizes the time it takes to switch from a first supply voltage to a second supply voltage by adjusting a precharge current to improve a fuel flow of the fuel injector, a maximum operation fuel pressure and other characteristics without reducing a tolerance of the fuel injector and the drive circuit (JP-A-2004-278411). This method uses a solenoid valve drive unit for internal combustion engines, which comprises: a detection means having at least two supply voltages to detect a current flowing in a solenoid valve; a comparison means to compare a solenoid valve current switching threshold for switching from the first supply voltage to the second supply voltage and the current detected by the detection means; a supply voltage switching means to initiate an actuation at the first supply voltage and, after the solenoid valve has become higher than the current switching threshold, switch to the second supply voltage; a precharge current supply means to supply current of a magnitude that does not result in a full response of the solenoid valve before applying the first supply voltage; a first voltage supply time comparison means to compare a first voltage supply time threshold and the first voltage supply time; and a precharge current adjusting means to adjust the precharge current supply time based on a result of the comparison.

### SUMMARY OF THE INVENTION

From the standpoint of reducing fuel consumption, there is a growing demand for reducing a minimum fuel volume that can be injected from a fuel injector. For further reduction of fuel consumption, there are also growing calls for performing a fuel cut operation, i.e., not injecting fuel, whenever an engine output is not necessary and for resuming a fuel injection operation following the fuel cut operation. When resuming the fuel injection, it is necessary to inject a small volume of fuel, equivalent to no load. For improved engine outputs and emissions control performance, a split injection is being performed. The split injection involves dividing the fuel volume normally required for one injection into a plurality of smaller fuel volumes and injecting them at different appropriate timings, thus improving the performance of the engine. In the split injection, therefore, the volume of fuel used in one injection needs to be reduced.

As the demands for improved engine performances grow as described above, the fuel injectors and the fuel injection control apparatus are increasingly required to be able to inject as small a volume of fuel as possible. When injecting small volumes of fuel, it is necessary to reduce a duration in which the fuel injector is kept open. In that case, a percentage of a time it takes for the fuel injector to move from a closed state to an open state (hereinafter referred to as an opening delay) with respect to the opening hold time increases. Errors in the opening delay therefore have great effects on an accuracy of the fuel injection amount or injection fuel mass. This opening delay changes depending on the pressure of fuel present around the plunger rod in the fuel injector and a fluid force produced by viscosity. As a result, the opening delay varies according to the operational state of the engine and the quality of fuel, causing fuel injection amount errors when injecting small volumes of fuel, thus preventing engine performance improvement.

To overcome the above problems with the fuel injection in internal combustion engine, it is an object of the present invention to provide and propose a fuel injection control apparatus capable of opening a fuel injector with high precision in a variety of operational states and for various fuel qualities.

To achieve the above objective, the fuel injection control apparatus of an internal combustion engine having at least one sensor to detect at least one operational state of the engine and a fuel injector to activate a plunger rod thereof to inject fuel when an excitation current is supplied to a coil of the fuel injector, comprises a means to precharge the coil of the fuel injector with an excitation current smaller than that required to activate the plunger rod of the fuel injector, wherein the current to be precharged is adjusted according to the operational state of the engine detected by the sensor.

According to further aspects of the present invention, the following fuel injection control apparatus are provided.
(1) A fuel injection control apparatus for internal combustion engine having a temperature sensor to detect a temperature of fuel to be supplied to a fuel injector or a computation unit to estimate the fuel temperature, comprising a fuel injector to activate a plunger rod thereof to inject fuel when an excitation current is supplied to a coil of the fuel injector; and a means to precharge the coil of the fuel injector with an excitation current smaller than that required to activate the plunger rod of the fuel injector; wherein the current to be precharged is adjusted according to the fuel temperature detected by the temperature sensor or the estimated fuel temperature.
(2) A fuel injection control apparatus for internal combustion engine according to (1), wherein at least a magnitude of the precharge current is changed according to the fuel temperature detected by the temperature sensor or the estimated fuel temperature.
(3) A fuel injection control apparatus for internal combustion engine according to (2), wherein at least the magnitude of the precharge current is increased as the fuel temperature detected by the temperature sensor or the estimated fuel temperature decreases.
(4) A fuel injection control apparatus for internal combustion engine according to any of (1) to (3), wherein at least a time during which a current is precharged is changed according to the fuel temperature detected by the temperature sensor or the estimated fuel temperature.
(5) A fuel injection control apparatus for internal combustion engine according to (4), wherein at least the time during which a current is precharged is increased as the fuel temperature detected by the temperature sensor or the estimated fuel temperature decreases.
(6) A fuel injection control apparatus for internal combustion engine having a sensor to detect an alcohol concentration in a fuel or a computation unit to estimate the alcohol concentration, comprising a fuel injector to activate a plunger rod thereof to inject fuel when an excitation current is supplied to a coil of the fuel injector; and a means to precharge the coil of the fuel injector with an excitation current smaller than that required to activate the plunger rod of the fuel injector; wherein the current to be precharged is adjusted according to the alcohol concentration or the estimated alcohol concentration.
(7) A fuel injection control apparatus for internal combustion engine according to (6), wherein at least a magnitude of the precharge current is changed according to the alcohol concentration detected by the sensor or the estimated alcohol concentration.
(8) A fuel injection control apparatus for internal combustion engine according to (7), wherein at least the magnitude of the precharge current is increased as the alcohol concentration detected by the sensor or the estimated alcohol concentration increases.
(9) A fuel injection control apparatus for internal combustion engine according to any of (6) to (8), wherein at least a time during which a current is precharged is changed according to the alcohol concentration detected by the sensor or the estimated alcohol concentration.
(10) A fuel injection control apparatus for internal combustion engine according to (9), wherein at least the time during which a current is precharged is increased as the alcohol concentration detected by the sensor or the estimated alcohol concentration increases.
(11) A fuel injection control apparatus for internal combustion engine comprising: a computation unit to calculate a magnitude of an excitation current to be applied to a coil of a fuel injector which activates a plunger rod thereof to inject fuel when an excitation current is supplied to the coil of the fuel injector, and a means to precharge the coil of the fuel injector with an excitation current smaller than that required to activate the plunger rod of the fuel injector; wherein the current to be precharged is adjusted according to the calculated magnitude of the excitation current.
(12) A fuel injection control apparatus for internal combustion engine according to (11), wherein at least the magnitude of the precharge current is changed according to the calculated magnitude of the excitation current.
(13) A fuel injection control apparatus for internal combustion engine according to (12), wherein at least the magnitude of the precharge current is increased as the calculated magnitude of the excitation current increases.
(14) A fuel injection control apparatus for internal combustion engine according to any of (11) to (13), wherein at least a time during which a current is precharged is changed according to the calculated magnitude of the excitation current.
(15) A fuel injection control apparatus for internal combustion engine according to (14), wherein at least the time during which a current is precharged is increased as the calculated magnitude of the excitation current increases.
(16) A fuel injection control apparatus for internal combustion engine comprising: a computation unit to calculate a time during which an excitation current is applied to a coil of a fuel injector which activates a plunger rod thereof to inject fuel when an excitation current is supplied to the coil of the fuel injector; and a means to precharge the coil of the fuel injector with an excitation current smaller than that required to activate the plunger rod of the fuel injector; wherein the current to be precharged is adjusted according to the calculated application time of the excitation current.
(17) A fuel injection control apparatus for internal combustion engine according to (16), wherein at least a magnitude of the precharge current is changed according to the calculated application time of the excitation current.
(18) A fuel injection control apparatus for internal combustion engine according to (17), wherein at least the magnitude of the precharge current is increased as the calculated application time of the excitation current decreases.
(19) A fuel injection control apparatus for internal combustion engine according to (16) or (17), wherein at least a time during which a current is precharged is changed according to the calculated application time of the excitation current.
(20) A fuel injection control apparatus for internal combustion engine according to (19), wherein at least a time during which a current is precharged is increased as the calculated application time of the excitation current decreases.
(21) A fuel injection control apparatus for internal combustion engine according to (20), wherein, when the calculated application time of the excitation current, as it increases, exceeds a predetermined application time of the excitation current, at least a time during which a current is precharged is set to zero.
(22) A fuel injection control apparatus for internal combustion engine having an air-fuel ratio sensor to detect an air-fuel ratio for each cylinder of an internal combustion engine or a computation unit to estimate an air-fuel ratio for each cylinder and a fuel injector provided to each cylinder and adapted to activate a plunger rod thereof to inject fuel when an excitation current is supplied to a coil of the fuel injector, the control apparatus comprising a means to precharge the coil of the fuel injector with an excitation current smaller than that required to activate the plunger rod of the fuel injector; wherein the current to be precharged to the fuel injector is adjusted for each cylinder according to the air-fuel ratio of each cylinder detected by the air-fuel sensor or estimated air-fuel ratio of each cylinder.
(23) A fuel injection control apparatus for internal combustion engine according to (22), wherein the current to be precharged to the fuel injector is adjusted for each cylinder in a region where an output of the engine is smaller than a predetermined value.
(24) A fuel injection control apparatus for internal combustion engine according to (22) or (23), wherein at least a magnitude of the precharge current is changed according to the air-fuel ratio of each cylinder detected by the air-fuel sensor or the estimated air-fuel ratio of each cylinder.
(25) A fuel injection control apparatus for internal combustion engine according to (24), wherein at least the magnitude of the precharge current is increased as the air-fuel ratio of each cylinder detected by the air-fuel sensor or the estimated air-fuel ratio of each cylinder increases.
(26) A fuel injection control apparatus for internal combustion engine according to (22) or (25), wherein at least a time during which a current is precharged is changed according to the air-fuel ratio of each cylinder detected by the air-fuel sensor or the estimated air-fuel ratio of each cylinder.
(27) A fuel injection control apparatus for internal combustion engine according to (26), wherein at least the time during which a current is precharged is increased as the air-fuel ratio of each cylinder detected by the air-fuel sensor or the estimated air-fuel ratio of each cylinder increases.
(28) A fuel injection control apparatus for internal combustion engine according to any one of (1) to (27), wherein an upper limit is set on the magnitude of the precharge current.
(29) A fuel injection control apparatus for internal combustion engine according to (28), wherein an upper limit is set on the length of time during which a current is precharged.

The present invention adjusts a precharge current applied to the fuel injector according to changes in operational state of an internal combustion engine and in fuel pressure and fuel quality or fuel mass, in order to minimize delays in opening the plunger rod of the fuel injector, thereby reducing errors of fuel injection volume caused by plunger rod opening delay.

Other objects, features and advantages of the invention will become apparent from the following description of the embodiments of the invention taken in conjunction with the accompanying drawings.

### BRIEF DESCRIPTION OF THE DRAWINGS

FIG. 1 shows an overall configuration of an internal combustion engine applying the fuel injection control apparatus of the present invention.

FIG. 2 shows a relation among a drive pulse to a fuel injector, an excitation current and a plunger rod stroke in the fuel injection control apparatus of the present invention.

FIG. 3 shows a relation among the drive pulse to the fuel injector, a plunger rod opening delay and a fuel injection amount in the fuel injection control apparatus of the present invention.

FIG. 4 shows a relation between the drive pulse and the excitation current when a precharge current is made variable in the fuel injection control apparatus of the present invention.

FIG. 5 shows another relation between the drive pulse and the excitation current when a precharge current is made variable in the fuel injection control apparatus of the present invention.

FIG. 6 shows a relation between a fuel state and a force generated by the precharge current and acting on the plunger rod of the fuel injector in the fuel injection control apparatus of the present invention.

FIG. 7 shows a relation between the drive pulse and the fuel injection amount when the precharge current is made variable in the fuel injection control apparatus of the present invention.

FIG. 8 is a flow chart of a fuel injection control in the fuel injection control apparatus of the present invention.

FIG. 9 is another flow chart of a fuel injection control in the fuel injection control apparatus of the present invention.

### DESCRIPTION OF THE EMBODIMENTS

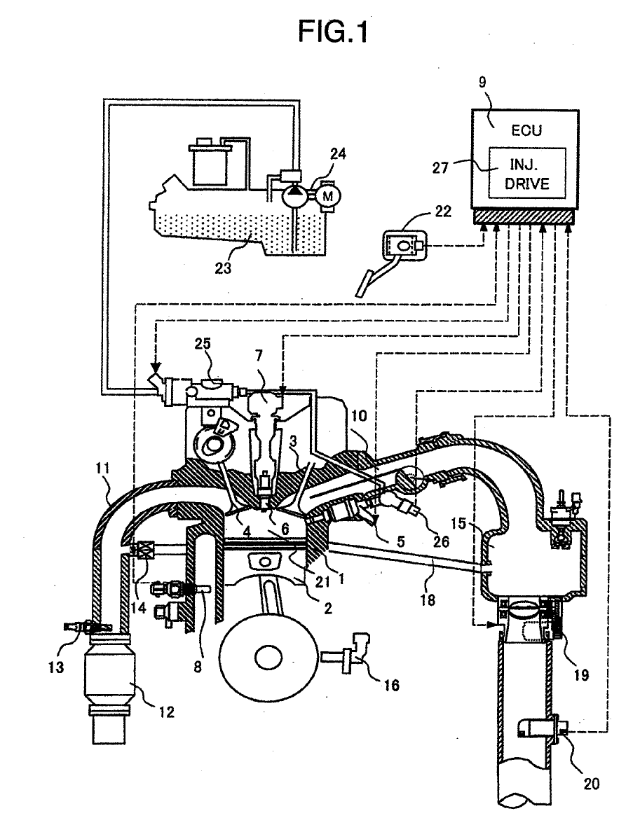

One embodiment of a fuel injection control apparatus for internal combustion engines according to the present invention will be described by referring to the accompanying drawings. FIG. 1 shows a basic configuration of an internal combustion engine and a fuel injection control apparatus for the engine. In the figure, an engine 1 has a piston 2, an intake valve 3 and an exhaust valve 4. Air drawn in passes through an air flow meter (AFM) 20 and a throttle valve 19 and, from an intake collector 15 or a branch portion, further flows into an intake manifold 10 and the intake valve 3 and into a combustion chamber 21 of the engine 1. A fuel is supplied from a fuel tank 23 by a low-pressure fuel pump 24 into the engine where it is pressurized by a high-pressure fuel pump 25 to a level required for fuel injection. The fuel is injected from a fuel injector 5 into the combustion chamber 21 where it is ignited by an ignition coil 7 and a spark plug 6. A pressure of the fuel is measured by a fuel pressure sensor 26. An exhaust gas produced as a result of combustion is discharged through the exhaust valve 4 into an exhaust pipe 11. The exhaust pipe 11 has a three-way catalytic converter 12 for purifying the exhaust gas. An ECU (engine control unit) 9 has a built-in fuel injection control unit 27 to receive a signal from a crank angle sensor 16 for the engine 1, an air volume signal from AFM 20, a signal from an oxygen sensor 13, an accelerator pedal position signal from an accelerator pedal position sensor 22 and a signal from the fuel pressure sensor 26. The ECU 9 calculates a demand torque from the accelerator pedal position sensor 22 signal and also checks if the engine is idling. The ECU 9 has a revolution detection unit that calculates an engine revolution from the crank angle sensor 16 signal and a unit to determine whether the three-way catalytic converter 12 is warmed up, from a water temperature of the engine from a water temperature sensor 8 and a time that has elapsed from the start of the engine. The ECU 9 also calculates a required volume of air to be drawn into the engine 1 and outputs a corresponding opening signal to the throttle valve 19. The fuel injection control unit 27 calculates a fuel volume that matches the air volume drawn in and outputs a fuel injection signal to the fuel injector 5 and an ignition pulse to the spark plug 6.

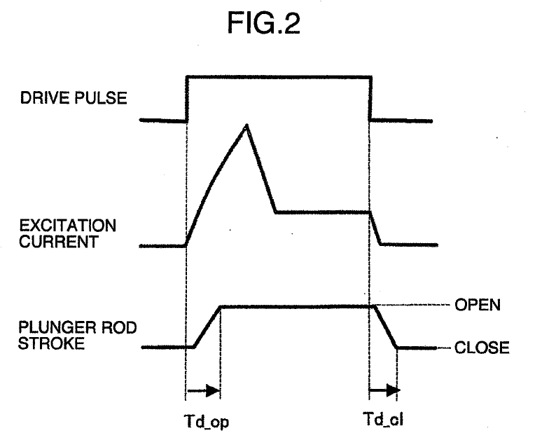

FIG. 2 schematically illustrates a driving pulse applied from the fuel injection control apparatus to the fuel injector and representing a time that the fuel injector is supposed to be open, an excitation current actually flowing in the coil of the fuel injector, and a stroke of a plunger rod of the fuel injector at the corresponding time. The plunger rod is acted upon by a fluid force because of a response delay of a circuit from the fuel injection control apparatus to the fuel injector or influences of the pressure, temperature and quality of the fuel present in the fuel injector. So delays Td_op, Td_c1 occur from the application of the driving pulse until the plunger rod actually opens or closes. These delays Td_op, Td_c1 of the plunger rod operation change according to the pressure, temperature and quality of the fuel.

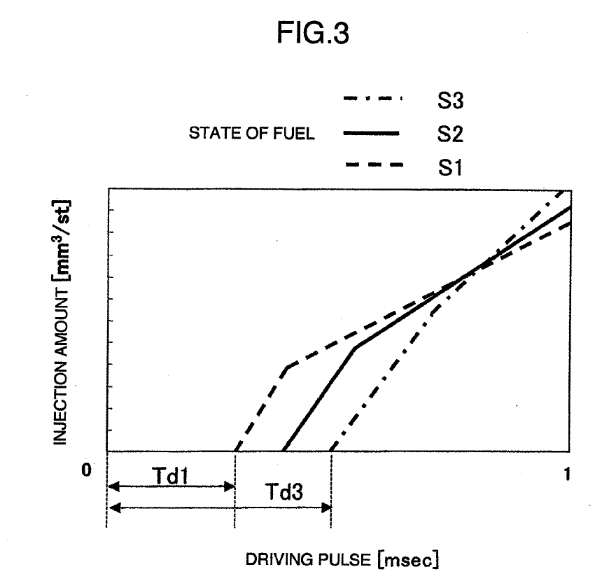

FIG. 3 shows a relation between an opening delay from the application of an driving pulse to the fuel injector and a fuel injection amount when a state of the fuel, for example, one of pressure, temperature and quality of the fuel, changes to S1, S2, S3. When a state of the fuel, for example, the fuel pressure, changes from S1 to S3, the opening delay Td1 increases to Td3, shifting an area where the relation between the driving pulse and the injection amount is linear toward right. This makes an accuracy of the fuel injection amount produced by a small driving pulse worse when the fuel pressure is high at S3 than when it is low at S1. This phenomenon is not just caused by a fuel pressure change but also by changes in viscosity resulting from fuel temperature changes and fuel quality (e.g., alcohol content) changes.

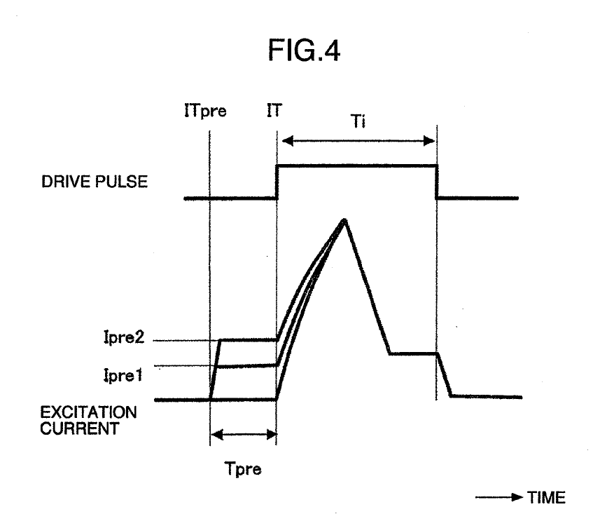

FIG. 4 shows an excitation current that the fuel injection control unit 27 applies to the fuel injector 5 for a duration of an driving pulse Ti that corresponds to a precharge length Tpre subtracted from a total length of the excitation current flowing in the fuel injector. The fuel injection control unit 27 calculates an appropriate fuel injection start timing IT and an opening hold time Ti of the injector according to the engine operational state. A precharge current of a magnitude Ipre is applied to the coil of the fuel injector 5 at a timing ITpre that occurs a length of time Tpre before the timing IT when the plunger rod of the fuel injector is supposed to be operated. The amplitude of Ipre is changed according to the operational state of the engine, such as a fuel pressure detected by the fuel pressure sensor 26, a target fuel pressure calculated by the ECU 9, or a fuel temperature and quality. When, for example, the fuel pressure has increased from P1 to P2, the precharge current is changed from Ipre1 to Ipre2. It is noted, however, that Ipre is changed in a range of magnitude that can only generate a magnetic force not large enough to cause the plunger rod of the fuel injector 5 to get operated and start injecting fuel.

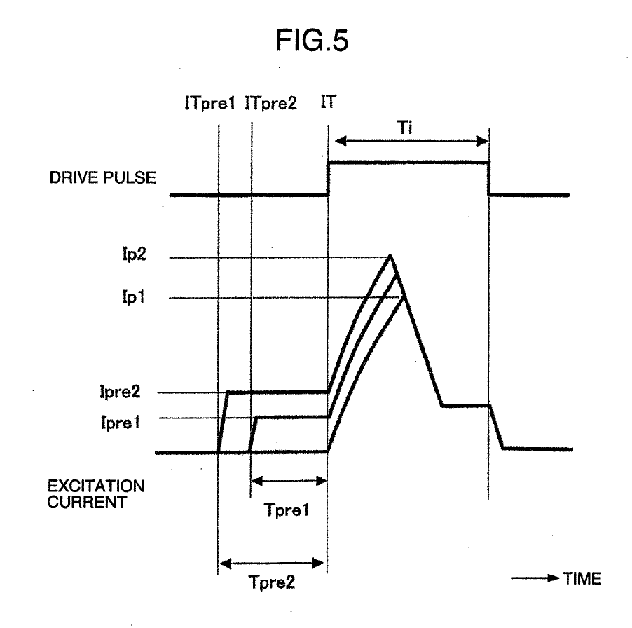

FIG. 5 shows how the fuel injection control unit 27 of this invention applies a drive current to the fuel injector 5 based on the driving pulse Ti. As in the case of FIG. 4, the magnitude of Ipre is changed according to the operational state of the engine, such as the fuel pressure detected by the fuel pressure sensor 26, the target fuel pressure calculated by the ECU 9, or fuel temperature and quality. In this case too, the magnitude of Ipre is changed only in a range that can only generate a magnetic force not large enough to cause the plunger rod of the fuel injector 5 to get operated and start injecting fuel. At the same time, the duration Tpre in which the precharge current is applied is also changed. When the precharge current is changed from Ipre1 to Ipre2, the current application duration Tpre is elongated from Tpre1 to Tpre2. This takes into account the delay of the current circuit to ensure that a desired precharge current Ipre flows as an excitation current in the coil of the fuel injector.

To move the plunger rod of the fuel injector quickly to the open position, a peak current Ip1, Ip2 of FIG. 5 may be added to the excitation current applied to the coil of the fuel injector. This is intended to increase the applied current to generate a greater magnetic force and thereby increase an opening speed of the plunger rod. Some fuel injection control apparatus make the target peak current variable. The reason for making the peak current variable is that the force required to open the plunger rod of the fuel injector changes according to the state of the fuel. That is, when a large opening force is required, the peak current is increased. At this time, an electric charge stored in a capacitor in the fuel injection control unit 27 is discharged as a current. When the target peak current is high, it takes time to reach the target value. To compensate for a delay, the magnitude of the precharge current needs to be increased according to the magnitude of the target peak current. Thus, when the target peak current changes from Ip1 to Ip2, the precharge current is also changed from Ipre1 to Ipre2. The precharge current Ipre should be kept within a range not high enough to cause the plunger rod of the fuel injector 5 to operate and start fuel injection. The duration Tpre may be increased from Tpre1 to Tpre2 as the Ipre increases. This takes the delay of the current circuit into account to ensure that a desired precharge current Ipre flows as an excitation current in the coil of the fuel injector.

The duration of the driving pulse, Ti, is calculated from the fuel volume required for the engine by the ECU 9 or the fuel injection control unit 27. When the fuel volume required for the engine is small, Ti is short. Thus, the opening delay of the plunger rod of the fuel injector becomes, as is, an error in the ejection volume, greatly affecting the performance of the engine. So, when Ti is small, the precharge current needs to be increased, for example, from Ipre1 to Ipre2 to increase the opening speed of the plunger rod and thereby reduce the opening delay. The precharge current Ipre is changed in a range not high enough to cause the plunger of the fuel injector 5 to operate and start fuel injection. The duration Tpre may be increased from Tpre1 to Tpre2 as the precharge current Ipre increases. This considers the delay of the current circuit to make sure that the desired Ipre flows as an excitation current in the coil of the fuel injector.

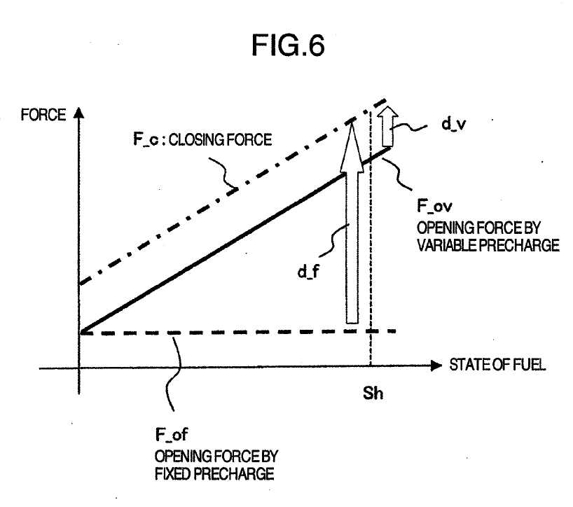

FIG. 6 shows a force that acts on the plunger rod of the fuel injector 5 to open it from the closed state when a precharge current flows in the coil, with an abscissa representing the state of fuel, such as fuel pressure, temperature and fuel quality (alcohol content). A force tending to close the plunger rod, F_c, is generated by a spring force and a fluid force of the fuel in the fuel injector 5. Of these, the fluid force generated by the fuel pressure increases with the increasing fuel pressure. Let the forces tending to open the plunger rod when a precharge current is applied to the fuel injector 5 be F_of and F_ov. A magnetic force generated by the coil of the fuel injector 5 is proportional to the current flowing in the coil. So, when the precharge current Ipre is constant, the force F_of that tends to open the plunger rod is also constant. In that case, the force F_c tending to close the plunger rod increases as the fuel pressure increases, so that when the fuel pressure is high at Sh, the plunger rod is not open until an additional current corresponding to a difference of force d_f required to open the plunger rod is applied from the point in time IT of FIG. 4 and FIG. 5. That is, Td-op of FIG. 2 increases. If the precharge current Ipre is made variable by the fuel pressure, the force to open the plunger rod can be made to change as shown at F_ov. In that case, even if the fuel pressure is high at Sh, the force difference can be kept almost constant at d_v at all times, rendering Td_op of FIG. 2 constant, independent of the fuel pressure. It is noted that this phenomenon is not only caused by the fuel pressure change but also by changes in viscosity resulting from fuel temperature changes and fuel quality (e.g., alcohol content) changes. Therefore, the above procedure can also be applied in the similar way for these changes.

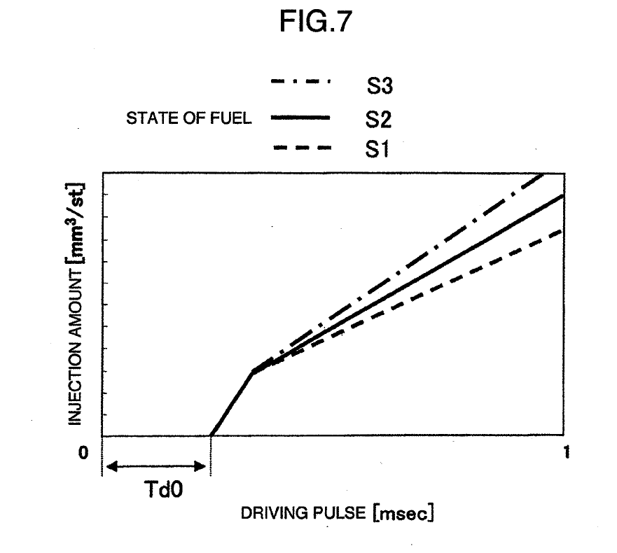

FIG. 7 shows a relation between an driving pulse for the fuel injector and a fuel injection amount when the precharge current Ipre is made variable according to the fuel state. While in FIG. 3 the opening delay increases as the fuel state changes, degrading the accuracy of the fuel injection amount, it is possible, as shown in FIG. 7, to make the opening delay constant, independent of the fuel state, by changing the precharge current Ipre according to the fuel state and thereby keeping constant the force difference d_v until the plunger rod of the fuel injector 5 begins to open. As a result, the accuracy of fuel injection amount becomes constant, independent of the fuel state.

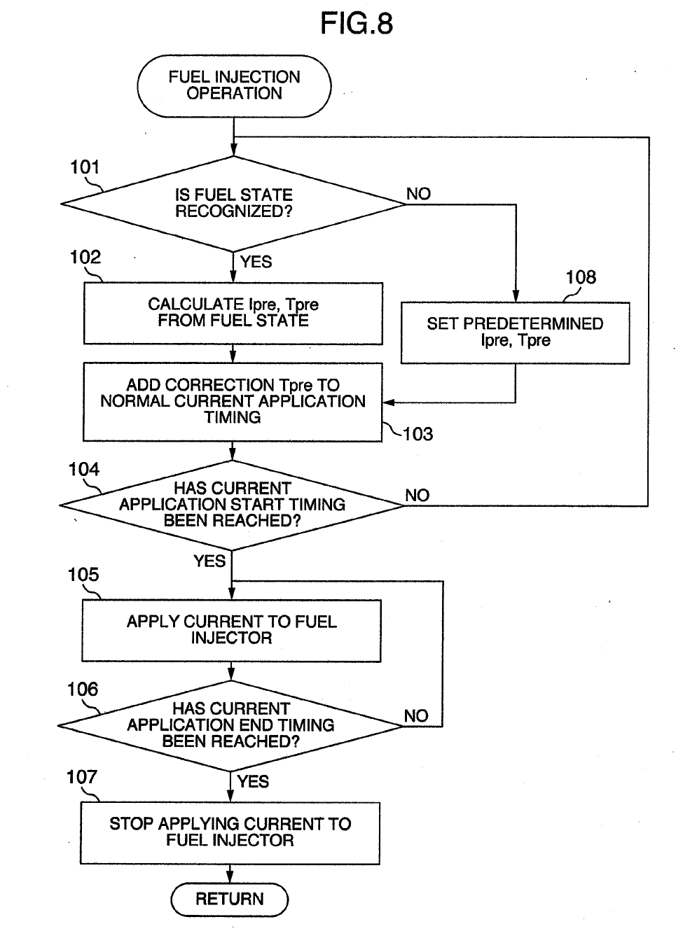

FIG. 8 is a flow chart of the fuel injection control executed according to this invention. It is assumed that the ECU 9 or the fuel injection control unit 27 is always calculating the current application start timing IT and the driving pulse width Ti for the fuel injector from the intake air volume measured by the AFM 20 and the operational state of the engine. Step 101 checks whether the fuel state is known. If so, step 102 calculates an appropriate precharge current Ipre and precharge current duration Tpre from the fuel state. If the fuel state cannot be recognized, step 108 sets predetermined Ipre and Tpre. Step 103 adds a correction of the calculated Tpre to the current application timing for the fuel injector to calculate ITpre. Step 104 checks if a timing generated based on a signal from the crank angle sensor 16 has reached the current application timing ITpre for the fuel injector. If so, step 105 starts applying the current. The excitation current flowing in the fuel injector at this time has a waveform of FIG. 5, for example, but is not limited to it. Step 106 checks if a current application end timing is reached and, if so, stops the current application.

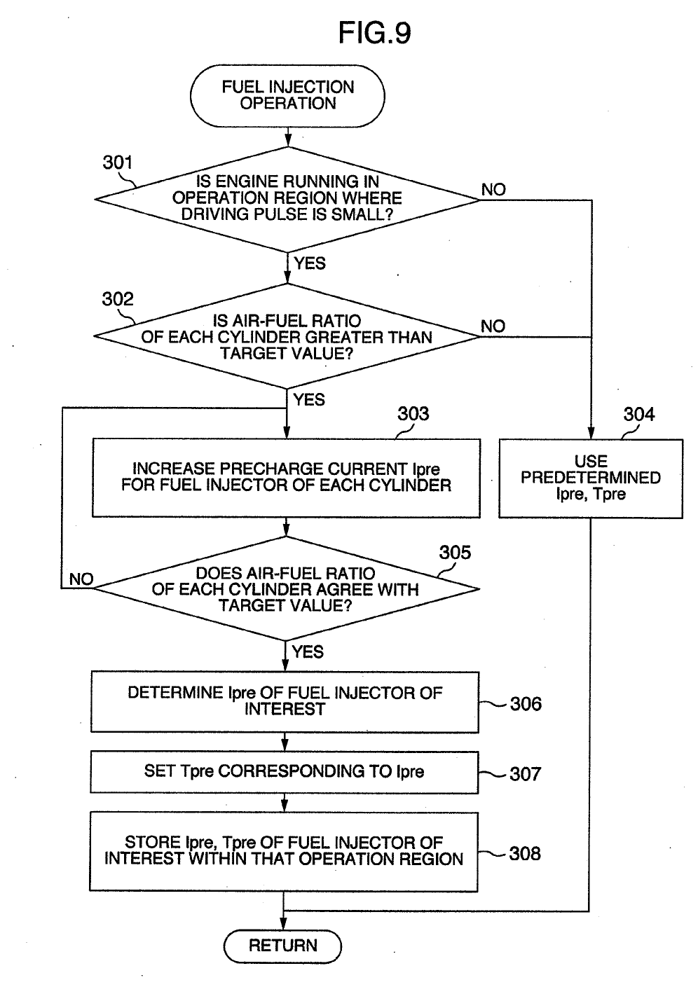

FIG. 9 shows a sequence of steps of the fuel injection control in an internal combustion engine having a plurality of cylinders when the ECU 9 has a function of calculating an exhaust gas air-fuel ratio for each cylinder directly from the air-fuel ratio sensor, which detects the air-fuel ratio of exhaust gas, or indirectly by estimation operation. Step 301 checks if the engine is running in an operation region where the required fuel injection amount is small and the driving pulse corresponds to the minimum variable pulse length of the fuel injector. Step 302 calculates an air-fuel ratio for each cylinder and compares them with a target air-fuel ratio. In a fuel injector whose air-fuel ratio is greater than the target air-fuel ratio, i.e., in a fuel injector corresponding to a cylinder with a small fuel injection amount, either the fuel injection amount is smaller than required or the volume of air flowing into that cylinder is greater than those in other cylinders. Step 303 increases the precharge current to a level not high enough to cause the plunger rod of the fuel injector to open. If step 305 finds that the air-fuel ratio of each cylinder is close to the target air-fuel ratio, it can be decided that the fuel injection amount is less than required because of the opening delay of the plunger rod. In that case, step 306 sets the precharge current of the fuel injector corresponding to the cylinder in question to an appropriate value. Step 307 increases the precharge duration according to the magnitude of the precharge current. Step 308 stores the set values of Ipre, Tpre of the fuel injector of interest running in the operation region as learned values in the ECU 9 or the fuel injection control unit. When the engine enters into the same operation region again, step 304 quickly applies an appropriate precharge current to the fuel injector, thereby injecting an appropriate volume of fuel.

The embodiments of the present invention have been described in detail. It is noted, however, that the present invention is not limited to the above embodiments and that the constitutional elements are also not limited to the above example as long as they do not lose the characteristic function of this invention.

It should be further understood by those skilled in the art that although the foregoing description has been made on embodiments of the invention, the invention is not limited thereto and various changes and modifications may be made without departing from the spirit of the invention and the scope of the appended claims.

1. A fuel injection control apparatus for an internal combustion engine having at least one sensor to detect at least one operational state of the internal combustion engine and a fuel injector to activate a plunger rod thereof to inject fuel when an excitation current is supplied to a coil of the fuel injector, said control apparatus comprising:
means for precharging the coil of the fuel injector with an excitation current smaller than that required to activate the plunger rod of the fuel injector,
wherein the current to be precharged is adjusted according to the operational state of the engine detected by the sensor.

2. The fuel injection control apparatus for internal combustion engine according to claim 1, wherein
said engine has a plurality of the fuel injectors, and
wherein the current to be precharged to each of the fuel injectors is adjusted according to the at least one operational state of the engine detected by the sensor.

3. The fuel injection control apparatus for internal combustion engine according to claim 1, wherein
at least a magnitude of the precharge current is changed according to the operational state of the engine detected by the sensor.

4. The fuel injection control apparatus for internal combustion engine according to claim 1, wherein
at least a time during which a current is precharged is changed according to the operational state of the engine detected by the sensor.

5. A fuel injection control apparatus for an internal combustion engine having a fuel injector to activate a plunger rod thereof to inject fuel when an excitation current is supplied to a coil of the fuel injector and a fuel pressure sensor to detect a pressure of fuel supplied to the fuel injector, said control apparatus comprising:
means for precharging the coil of the fuel injector with an excitation current smaller than that required to activate the plunger rod of the fuel injector,
wherein the current to be precharged is adjusted according to the fuel pressure detected by the fuel pressure sensor.

6. The fuel injection control apparatus for internal combustion engine according to claim 5, wherein
at least a magnitude of the precharge current is changed according to the fuel pressure detected by the fuel pressure sensor.

7. The fuel injection control apparatus for internal combustion engine according to claim 6, wherein
at least a magnitude of the precharge current is increased as the fuel pressure detected by the fuel pressure sensor increases.

8. The fuel injection control apparatus for internal combustion engine according to claim 5, wherein
at least a time during which a current is precharged is changed according to the fuel pressure detected by the fuel pressure sensor.

9. The fuel injection control apparatus for internal combustion engine according to claim 8, wherein
at least a time during which a current is precharged is increased as the fuel pressure detected by the fuel pressure sensor increases.

10. The fuel injection control apparatus for internal combustion engines according to claim 5, wherein,
when the fuel pressure sensor fails or when the fuel pressure cannot be recognized, a magnitude of the precharge current is set to a predetermined fixed value.

11. The fuel injection control apparatus for internal combustion engine according to claim 5, wherein,
when the fuel pressure sensor fails or when the fuel pressure cannot be recognized, a time during which a current is precharged is set to a predetermined fixed value.

12. A fuel injection control apparatus for internal combustion engine having a fuel injector to activate a plunger rod thereof to inject fuel when an excitation current is supplied to a coil of the fuel injector, said control apparatus comprising:
a computation unit to calculate a target pressure of fuel to be supplied to the fuel injector; and
means for precharging the coil of the fuel injector with an excitation current smaller than that required to activate the plunger rod of the fuel injector,
wherein the current to be precharged is adjusted according to the calculated target fuel pressure.

13. The fuel injection control apparatus for internal combustion engine according to claim 12, wherein
at least a magnitude of the precharge current is changed according to the calculated target fuel pressure.

14. The fuel injection control apparatus for internal combustion engine according to claim 13, wherein
at least a magnitude of the precharge current is increased as the calculated target fuel pressure increases.

15. The fuel injection control apparatus for internal combustion engine according to claim 12, wherein
at least a time during which a current is precharged is changed according to the calculated target fuel pressure.

16. The fuel injection control apparatus for internal combustion engine according to claim 15, wherein
at least a time during which a current is precharged is increased as the calculated target fuel pressure increases.
